(19) United States
(12) Patent Application Publication
(10) Pub. No.: US 2008/0141882 A1
(43) Pub. Date: Jun. 19, 2008

(54) Imaging device

(76) Inventors: David Sabo, San Diego, CA (US); Ziv Gilan, Rehovot (IL); Dustin W. Blair, San Diego, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/580,573

(22) Filed: Oct. 13, 2006

(51) Int. Cl. B41K 1/38

(52) U.S. Cl. 101/335

(57) ABSTRACT

One embodiment of an imaging device includes an ink holder adapted for holding ink and an ink flow restriction device positioned within the ink holder, the ink flow restriction device including structure for defining a variable fluid resistance along a length of the ink flow restriction device.

### BACKGROUND

Imaging devices, namely, printers, may utilize fluid, such as ink, from an ink holder during use. The ink may be fed from an ink reservoir to an ink development engine that is located inside of an ink holder. This development engine may deliver ink to an imaging structure, such as a photo imaging drum, for printing of an image. The excess ink may then be collected from the imaging structure, transferred back through the development engine to the ink holder, and then recirculated back to the ink reservoir for further re-use. Leakage of ink from the ink holder during this recirculation loop may result in damage to the printing device or a reduction of print quality. Reducing leakage may also allow an increase in flow rates of ink within the imaging device which may increase throughput of the imaging device. Accordingly, it may be desirable to provide an ink holder that reduces ink leakage therefrom.

### BRIEF DESCRIPTION OF THE DRAWINGS

FIG. 1 is a side, partial cross-sectional view of one embodiment of an imaging device including several ink holders positioned radially around an imaging structure.

FIG. 2 is a detailed side cross-sectional view of one embodiment of an ink holder of FIG. 1.

FIG. 3 is a front cross-sectional view of the ink holder of FIG. 2 including a flow restriction structure therein.

FIG. 4 is a top view of the flow restriction structure of FIG. 3.

### DETAILED DESCRIPTION OF THE DRAWINGS

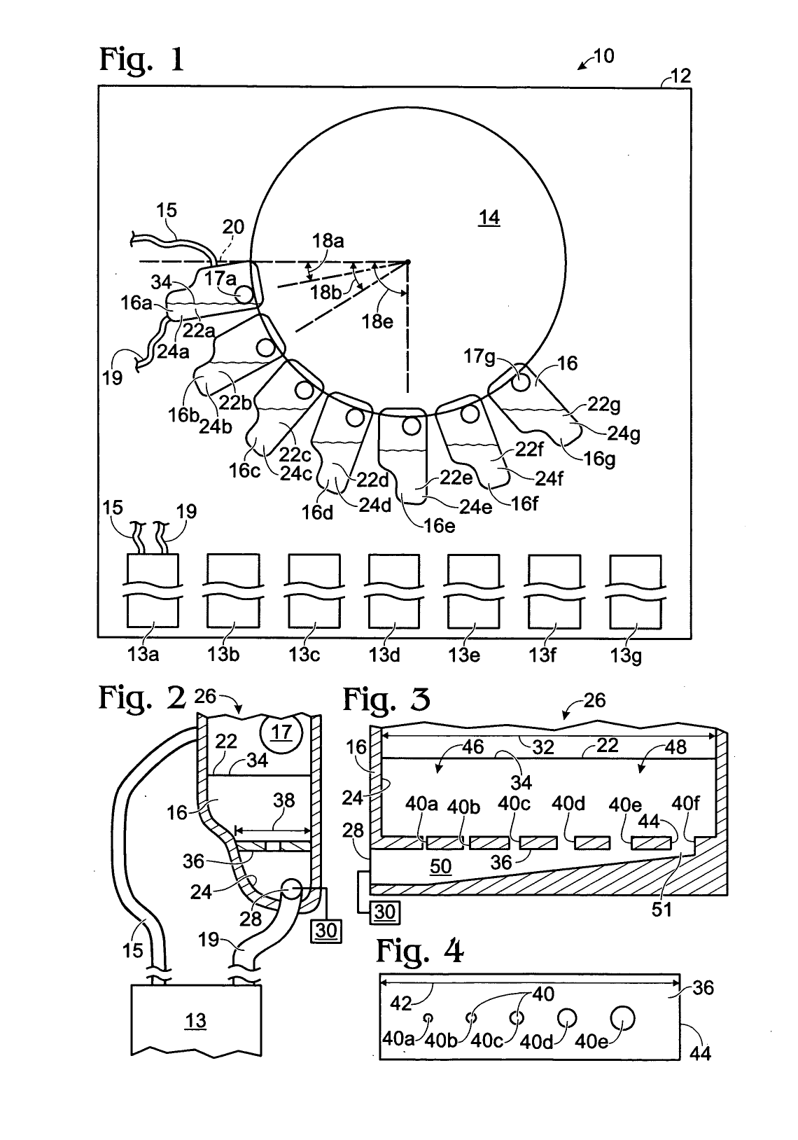

FIG. 1 is a side, partial cross-sectional view of one embodiment of an imaging device 10 including a housing 12, a set of ink reservoirs 13, and an imaging structure 14 positioned therein. In one embodiment imaging device 10 may be a printer and imaging structure 14 may be a photo imaging drum or a photo imaging plate. A plurality of ink holders 16 that each contain an ink development engine 17 may be positioned radially around imaging structure 14. In the embodiment shown, seven ink holders 16a-16g are positioned around imaging structure 14. Each of ink holders 16 has a corresponding ink reservoir 13a-13g and may be dedicated to a particular ink. For example, ink holder 16a and ink reservoir 13a may hold black ink, ink holder 16b and ink reservoir 13b may hold cyan ink, ink holder 16c and ink reservoir 13c may hold magenta ink, and the like. Each set of ink holders 16 and ink reservoirs 13 may define a circulation loop of its dedicated, particular ink. Ink reservoirs 13 may be substantially larger than ink holder 16 such that a large volume of ink may be utilized within imaging device 10. Each ink holder 16 may be connected to its corresponding ink reservoir 13 by a supply and a return hose 15 and 19, respectively.

The ink loop cycles ink through ink development engine 17 to imaging structure 14, with the leftover ink returning to ink holder 16, and thereafter, from ink holder 16 back to ink reservoir 13 through ink return hose 19 and up again through ink supply hose 15 to ink development engine 17 and imaging structure 14. For example, black ink from holder 16a may be fed to image structure 14 through ink development engine 17a for printing of black ink within an image. Excess black ink may be received from ink development engine 17a and transferred to ink holder 16a. The black ink may then move through ink holder 16a and be re-circulated back to ink reservoir 13a before being passed to ink development engine 17a again for further printing.

As shown in the embodiment of FIG. 1, ink holder 16a is positioned at an angle 18a of approximately sixteen degrees from a horizontal plane 20. Each of the successive ink holders 16b-16g are positioned at increasing angles 18b-18g, respectively, from horizontal plane 20, with ink holder 16e positioned at approximately ninety degrees from horizontal plane 20, i.e., approximately vertically.

Referring to FIGS. 1 and/or 2, each of ink holders 16 include ink 22 within an ink well region 24a-24g of each ink holder 16a- 16g, respectively. Ink holder 16e, being positioned substantially upright at an angle 18e of approximately ninety degrees with respect to horizontal plane 20, may have the lowest chance of ink leakage from the ink holder 16e during recirculation of ink 22e from ink well region 24e, to ink reservoir 13e. Ink holder 16a, being positioned at an angle 18a of approximately only sixteen degrees with respect to horizontal plane 20, may have the greatest chance of ink 22a leakage from ink holder 16a during recirculation of ink 22a from ink well region 24a, to ink reservoir 13a. Accordingly, the present invention provides an insert within each ink holder 16 to reduce ink leakage from the ink holders, as will be described below.

Each ink holder 16 includes an ink inlet 26, such as an open top or an inlet port, for receiving ink leftover ink from ink development engine 17. Excess ink 22 may be received within ink inlet 26 by gravity or any other ink receiving means. Each ink holder 16 may further include an ink outlet 28 or drain, which may be positioned opposite ink holder 16 from ink inlet 26. In the embodiment shown, ink outlet 28 is shown as an aperture in a lower region of ink well region 24, for ease of illustration. However, other locations or embodiments of ink outlet 28 may be utilized.

Referring to FIGS. 2 through 4, an ink transfer device 30, such as a vacuum or siphon pump (shown schematically) may be connected to ink outlet 28 for pulling ink 22 from ink holder 16 and transferring the ink 22 to ink reservoir 13 (see FIG. 1) so it can be returned to the ink development engine 17 for further imaging. An effective siphon for pulling ink 22 from ink well 24 may be maintained if the presence of continuous slugs of air is eliminated or reduced from the region of ink outlet 28. Accordingly, it may be desirable to provide an even flow of ink 22 downwardly within ink well 24, along a length 32 of ink well 24, such that a top surface 34 of ink 22 within ink holder 16 remains substantially flat and level along length 32 of ink well 24. In other words, ink level top surface 34 should lower uniformly along length 32 of ink well 24, and not dip substantially in the region above ink outlet 28, to provide increased effectiveness of ink transfer device 30. To provide such a substantially flat and level ink top surface 34 within ink well 24, the present invention provides an ink flow restriction device 36 positioned within each of ink holders 16.

Referring still to FIGS. 2 through 4, an ink flow restriction device 36 may be positioned within ink well 24 of ink holder 16 substantially along length 32 (FIG. 3) of ink well 24 and substantially along a width 38 (FIG. 2) of ink well 24. Accordingly, ink flow restriction device 36 may force all ink received through ink inlet port 26 to flow through or around ink flow restriction device 36 before exiting ink holder 16 through ink outlet port 28. Ink flow restriction device 36 may be structured as an independent plate or insert positioned within ink well 24, or may be manufactured as an integral component of ink well 24. In an embodiment wherein ink flow restriction device 36 is manufactured independent of ink well 24, the flow restriction device 36 may be secured in any manner within ink well 24, such as by a friction “snap” fit, by adhesive, or by any other method.

As shown in FIG. 4, in the embodiment shown, ink flow restriction device 36 is a plate including a plurality of apertures 40 arranged in a linear series along a length 42 of restriction device 36. A first aperture 40a positioned closest to ink outlet 28 (FIG. 3) may. define the smallest cross sectional area of the series of apertures 40. Each of the cross sectional areas of the apertures may increase as the distance of the aperture from ink outlet 28 is increased such that a fifth aperture 40e positioned farthest from ink outlet port 28 (FIG. 3) may define the largest cross sectional areas of the series of apertures 40. Additionally, ink flow restriction device 36 may not extend completely along length 32 of ink well 24 such that a rear edge 44 of restriction device 36 may function as a large, sixth aperture 40f within ink well 24.

Referring to FIGS. 1 through 4, operation of ink flow restriction device 36 within imaging device 10 will now be described. Leftover ink 22 from ink development engine 17 may be received within ink inlet 26 of ink well 24. The ink 22 may form a top surface 34 within ink well 24, wherein top surface 34 of ink 22 may be positioned above ink flow restriction device 36. Ink transfer device 30, connected to ink outlet 28, may pull a siphon on ink 22 to transfer ink to ink reservoir 13. This ink 22 may then be pumped through ink development engine 17 and back to imaging structure 14.

Pulling a siphon or vacuum pressure on ink 22 through ink outlet 28 may cause a higher fluid velocity in a region 50 adjacent ink outlet 28 and may cause a lower fluid velocity in a region 51 adjacent rear edge 44 of ink flow restriction device 36. As a result, the dynamic pressure below the plate is lowest near the outlet and highest in region 51 adjacent rear edge 44 of ink flow restriction device 36. The cross sectional area of each of apertures 40 may be sized to cause the volumetric flow of ink 22 through each of apertures 40a-40e, and around rear edge 44 which forms aperture 40f, for example, to be substantially the same along length 32 of ink well 24. This is achieved by sizing the apertures to provide higher fluidic resistance in areas that have higher pressure gradients. The calculation of the cross sectional area size of each of apertures 40a-f, for example, may be determined by any method as may be applicable. In particular, above the restriction device 36, the pressure may be substantially constant over the length of restriction device 36. However, below restriction device 36, the pressure may vary along the length of the restriction device 36, namely, region 50, just below aperture 40a may have a lower pressure than region 51, the area just below aperture 40f. This difference in pressure in different regions below restriction device 36 may be a result of the fluid velocity being much higher closer to outlet 28, due to the difference in sizes of the apertures within restriction device 36.

Accordingly, ink flow restriction device 36 may provide a substantially even volumetric flow rate of ink 22 through restriction device 36 and along length 32 of ink well 24, such that top surface 34 of ink 22 remains substantially level and does not dip or churn in a region of ink outlet 28, such that continuous slugs of air are not pulled into ink outlet 28. The reduction or elimination of continuous slugs of air within ink outlet 28 may increase the effectiveness of ink transfer device 30. Moreover, providing a substantially even or level top surface 34 of ink 22 within ink holder 16 may reduce spillage or leakage of ink 22 from ink holder 16 out of open top region 26, when top surface 34 of ink 22 may be positioned close to open top region 26, such as in the case of ink holder 16a (FIG. 1) positioned at approximately sixteen degrees from horizontal plane 20. A level top surface 34 of ink 22 may also reduce stagnation points within ink holder 16, thereby reducing sludge buildup within the holder.

Providing a level top surface 34 of ink may also have additional benefits. A level top surface 34 of ink 22 may allow a lower fluid level to be utilized within ink well 26, may allow greater flow rates of ink 22 to be utilized which may improve throughput of the imaging device, and may allow more extreme angles of ink holders 16 positioned with respect to imaging structure 14. A level top surface 34 of ink 22 may also reduce foam production within ink development engine 17 by providing a top surface 34 of ink within ink well 26 below a sponge roller (not shown) of the ink development engine 17. Reduction of foam and bubbles within the ink development engine 17 may further enhance the print quality of the imaging device.

Other variations and modifications of the concepts described herein may be utilized and fall within the scope of the claims below.

We claim:

1. An imaging device, comprising:
an ink holder adapted for holding ink; and
an ink flow restriction device positioned within said ink holder, said ink flow restriction device including structure for defining a variable fluid resistance along a length of said ink flow restriction device.

2. The device of claim 1 wherein said ink flow restriction device comprises a plate and wherein said structure for defining a variable fluid resistance comprises a plurality of apertures in said plate.

3. The device of claim 2 wherein said ink holder includes an ink outlet port and each aperture of said plurality of apertures defines a cross sectional area, and wherein a size of said cross sectional area of each aperture is related to a distance of said aperture from said ink outlet port.

4. The device of claim 3 wherein said size of said cross sectional area of each aperture increases as said distance of said aperture from said ink outlet port increases.

5. The device of claim 1 wherein said ink holder includes an open top through which ink is received within said ink holder, and wherein said ink flow restriction device is positioned between said open top and said ink outlet port such that ink received within said open top flows through one of said plurality of apertures to said ink outlet port.

6. The device of claim 1 wherein said structure for defining a variable fluid resistance is structured to provide level draining of ink from said ink holder along a length of said ink holder.

7. The device of claim 4 wherein said ink flow restriction device includes five apertures evenly spaced along a length of said ink holder.

8. An imaging device, comprising:
an ink container structured for transferring ink from an ink inlet port to an ink outlet port connected to an imaging structure; and
an insert positioned within said ink container between said ink inlet port and said ink outlet port and including a plurality of apertures sized to provide a fluidic resistance to ink flow through said plurality of apertures, said fluidic resistance of each aperture related to a distance of said each aperture from said ink outlet port.

9. The device of claim 8 wherein said insert comprises a plate that defines a length and wherein said plurality of apertures comprises a linear array of apertures positioned along said length of said plate.

10. The device of claim 8 wherein said imaging structure is a photo imaging plate and said ink container is a binary ink developer tray.

11. The device of claim 8 further comprising a second ink container structured for transferring ink from a second ink inlet port to a second ink outlet port connected to said imaging structure, and a second insert positioned within said second ink container and including a plurality of apertures sized to provide a fluidic resistance to ink flow through said plurality of apertures of said second insert, said fluidic resistance of each aperture of said second insert related to a distance of said each aperture from said second ink outlet port.

12. The device of claim 8 further including a siphon pump connected to said ink outlet port, said siphon pump pulling ink from said ink container through said outlet port wherein said plurality of apertures of said insert maintains an even fluid level of ink along a length of said ink container during pulling of ink from said ink container.

13. The device of claim 1 I1 further comprising an imaging drum, and wherein said ink container and said second ink container are positioned radially around said imaging drum.

14. An ink tray comprising:
an ink well including an opening for receiving excess ink from a development device and including a drain for transferring ink to an ink reservoir for recirculation to said development device; and
an ink flow restriction plate positioned between said opening and said drain and including a series of apertures structured to provide a uniform ink flow rate through the plate along a length of the plate.

15. The device of claim 14 wherein a cross sectional area of a first aperture of said series of apertures is larger than a cross sectional area of a second aperture of said series of apertures when said second aperture is positioned closer to said drain than said first aperture.

16. The device of claim 14 wherein said ink tray is dedicated to a single type of ink chosen from the group consisting of black ink, cyan ink, magenta ink, and yellow ink.

17. The device of claim 14 wherein said ink flow restriction plate is structured to reduce air flow into said drain from said ink well.
